(19) United States
(12) Patent Application Publication
(10) Pub. No.: US 2007/0063906 A1
(43) Pub. Date: Mar. 22, 2007

(54) Integrated antenna with coupled ground

(76) Inventor: Richard Langley, Kent (GB)

Correspondence Address: DICKSTEIN SHAPIRO LLP, 1177 AVENUE OF THE AMERICAS (6TH AVENUE), NEW YORK, NY, 10036-2714, US

(21) Appl. No.: 10/571,843

(22) PCT Filed: Sep. 15, 2004
(86) PCT No.: PCT/GB04/03933

§ 371 Date: Nov. 27, 2006

(30) Foreign Application Priority Data
Sep. 15, 2003 (GB) 0321625.6

(51) Int. Cl. H01Q 1/32

(52) U.S. Cl. 343/713; 343/711

(57) ABSTRACT

An integrated antenna includes a dielectric on which is patterned an antenna element and on which, close to an edge of the dielectric, is also patterned a conductive ground coupling member. The ground coupling member is capable of electricalcoupling with a grounded body surrounding the dielectric to provide a ground for an unbalanced transmission line whose live is connected to the antenna element. The length of the ground coupling member is made such that an integral odd number of quarterwavelengths of signals at each operating frequency are adapted to extend either side of a signal-ground connection point; the length approximates one-half wavelength at the primary operating frequency. By including a second signal feedline to extend in parallel with the ground coupling member and connect with another antenna element, it is possible for the integrated antenna to receive/transmit on at least two frequencies. The invention finds application in integrated antenna structures in which a local ground connection is not readily possible. For instance, the dielectric and grounded body may be a respective window and chassis of a car. Another automotive application involves forming the integrated antenna on a plastic boot lid.

The subject invention relates to integrated vehicular antennas and, more particularly, to unbalanced-type integrated vehicular antennas that have a signal feed point at an electrically-large distance from vehicular ground.

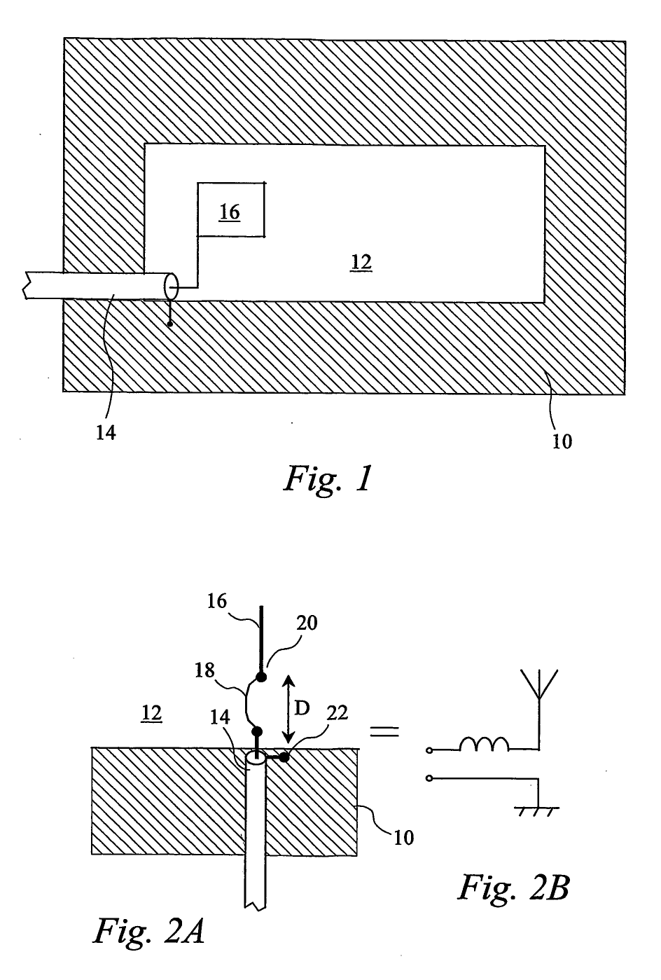

Increasing use is being made in vehicles of integrated antennas for reception of broadcast radio and television signals. Typical antenna solutions employ an unbalanced arrangement of the type illustrated in FIG. 1. In that figure, an aperture of a vehicle body 10 is filled by a dielectric 12. The dielectric 12 might be a window of the vehicle, but could also be another part of the vehicle (such as an insert in a boot, as further discussed below). An unbalanced transmission line 14 is connected to a main element 16 of an antenna formed on the dielectric 12. For simplicity the aperture is shown as rectangular and closed; in practice, the dielectric 12 will be a three-dimensional structure such as a vehicle windscreen, and the periphery of the aperture in the body 10 will have a complementary three-dimensional shape. Although FIG. 1 illustrates a closed aperture, it should be kept in mind that the following comments may relate to any region in which a dielectric interfaces with a grounded body; thus the description is equally applicable to a dielectric that has a grounded body along only a portion of its periphery.

In the structure of FIG. 1, the dielectric 12 is glass, and the antenna element 16 is typically formed on such glass as a pattern of conductive ink. Known arrangements are disclosed in EP Appln. 00 155 647 and WO Patent Publication WO 99/66587, which make use of a vehicle rear window having a heater grid. As an alternative, U.S. Pat. No. 3,771,159 and EP Appln. 00 854 533 use printed elements on vehicle side windows. Increasing use is also being made of dielectrics formed by plastic body parts, such as the roof panel of UK Appln. 0203917; in that case, the antenna element is formed by a conductive pattern on a thin dielectric substrate (a film antenna), and the substrate is fixed to the underside of the roof panel.

Such antennas are unbalanced, since the vehicle body is large enough to be considered “earth”; as such, connection to the antenna is made using an unbalanced transmission line. In FIG. 1 the transmission line 14 takes the form of a coaxial cable, but it may take a different form. For instance, in a typical active antenna the transmission line might be a microstrip line as part of a printed circuit board (PCB) in an amplifier module. Of importance is that, when the signal feedline of the unbalanced transmission line is connected to the feed point of the antenna element, the earth of the transmission line is connected to the vehicle earth close to that feed point. The position of the earth connection is vital to ensure that the antenna element is excited correctly, i.e. images of currents on the earth plane must flow into the feed point of the antenna element.

Although such antennas have been developed successfully in a wide range of applications, the requirement for the earth connection to be proximate the feed point of the antenna element has presented restrictions. The subject invention seeks to overcome those restrictions.

The restrictions can be further understood by considering FIGS. 2A and 2B. In FIG. 2A, connection of the coaxial cable 14 to the antenna element 16 requires the presence of a connecting wire 18. The wire 18 effectively extends between an input end 20 of the antenna 16 and the location 22 (FIG. 2A) at which outer ground-shielding, surrounding the “live” of coaxial cable 14, connects to the vehicle body 10. The length “D” shown in FIG. 2A is critical to the performance of the antenna. The connecting wire 18 may be considered to be acting as a part of the antenna element 16, presenting a series inductance (as depicted schematically in FIG. 2B) with the antenna element 16. Such series inductance severely limits the antenna performance.

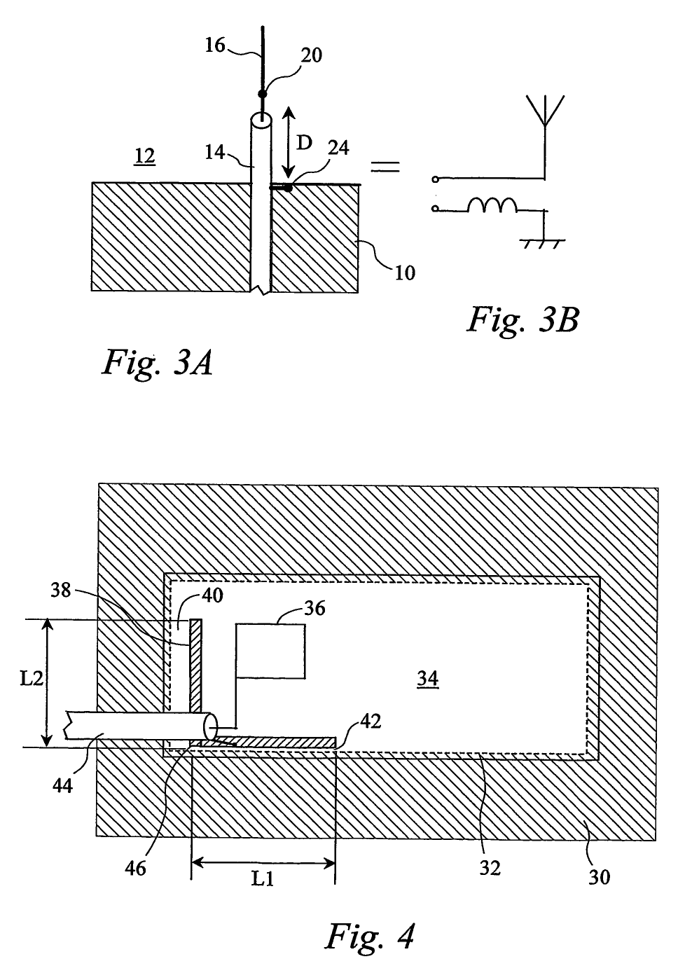

If, as shown in FIG. 3A, the coaxial cable 14 with its outer ground-shielding is extended by the distance “D” to the input end 20 of the antenna 16 (with the outer ground-shielding still connecting to the vehicle body 10 at location 22), there is still a difficulty. Currents will flow in the outer ground-shielding, introducing inductance to ground, and may also disturb currents in the antenna element 16; such inductance is shown schematically in FIG. 3B.

Note that if a mono-pole is fed part-way up the antenna element 16, impedance increases with a reduction in efficiency. Many integrated antennas avoid this problem by keeping the connecting wire 18 “electrically-small”, i.e. typically less than 10 cm for FM antennas. However, there are a number of applications where that is not possible. Use of the subject invention is intended to overcome the difficulty in those applications, which include:

(1) antennas on moveable panels, such as hinged plastic boot lids, where feeding cable runs over a hinge and there is a 50 cm to 60 cm minimum distance between the antenna element and the vehicle earth (which is in the order of FM wavelength frequencies); and,

(2) antennas operating at higher frequencies, for instance, DAB antennas operating in Europe at 1.5 GHz, where a typical 10 cm feeding cable is “electrically-long”, i.e. in the order of a half of the wavelength.

One form of the subject invention is an antenna assembly that includes; a dielectric adapted to be fitted into a grounded frame; a ground coupling member, extending on the dielectric and having first and second signal-ground connection points, the position of the ground coupling member on the dielectric being such that when the dielectric is fitted into the grounded frame the ground coupling member and the frame are spaced from each other but have an electrical coupling; a first antenna element patterned on the dielectric to extend to a first signal-feed connection point on the dielectric, the first signal-feed connection point being located proximate the first signal-ground connection point; and, a second antenna element patterned on the dielectric to extend to a second signal-feed connection point on the dielectric, the second signal-feed connection point being located proximate the second signal-ground connection point. If λ₁ and λ₂ designate the wavelengths of signals respectively associated with the first and second antenna elements: the length of the ground coupling member is equal to mλ₁/2 and nλ₂/2, where m and n are integers and not simultaneously equal to 1; the distance separating the first signal-feed connection point from the second signal-feed connection point is greater than λ₂/4, where λ₂≦λ₁; the first signal-feed connection point is located proximate the first ground coupling member at a distance λ₁/4, or an odd-integer multiple of that distance, from one end of the ground coupling member; and, the second signal-feed connection point is located proximate the second ground coupling member at a distance λ₂/4, or an odd-integer multiple of that distance, from the one end of the ground coupling member.

Preferably, λ₁ is equal to λ₂, and signals associated with the first antenna element are 180° out-of-phase with signals associated with the second antenna element.

Preferably, m and n are both 2, and the first and second signal-feed connection points are separated by λ₂/2.

Preferably, m and n are both 3, and the first and second signal-feed connection points are separated by λ₂/2 or λ₂.

Preferably, m and n are both 4, and the first and second signal-feed connection points are separated by λ₂/2, λ₂, or 3λ₂/2.

Another form of the subject invention is an antenna assembly that includes: a dielectric adapted to be fitted into a grounded frame; a ground coupling member, extending on the dielectric and having a signal-ground connection point, the position of the ground coupling member on the dielectric being such that when the dielectric is fitted into the grounded frame the ground coupling member and the frame are spaced from each other but have an electrical coupling; a first antenna element patterned on the dielectric to extend to a signal-feed connection point on the dielectric; and, a second antenna element patterned on the dielectric to extend to the signal-feed connection point, a feed portion of the second antenna element extending generally parallel to the ground coupling member from the signal-feed connection point to a feed-portion termination point. The wavelengths of signals associated with the first antenna element are twice, or a multiple of twice, the wavelengths of signals associated with the second antenna element. The distance between the signal-feed connection point and the feed-portion termination point is approximately one-quarter wavelength, or an odd-integer multiple of that one-quarter wavelength, of signals associated with the second antenna element.

Preferably, the feed-portion termination point is separated from a closer first end of the ground coupling member by a distance equal to one-quarter wavelength, or an odd-integer multiple of that one-quarter wavelength, of signals associated with the second antenna element.

Preferably, the signal-feed connection point is separated from the second end of the ground coupling member by a distance equal to one-quarter wavelength, or an odd-integer multiple of that one-quarter wavelength, of signals associated with the first antenna element.

Preferably, the length of the ground coupling member approximates one-half wavelength of signals associated with the first antenna element.

Preferably, the length of the ground coupling member approximates the wavelength of signals associated with the second antenna element.

The following preferred features are applicable to both forms of the subject invention.

Preferably, the electrical coupling is adapted to be between the ground coupling member and a co-planar portion of the frame.

Preferably, the electrical coupling is capacitive coupling.

Preferably, the ground coupling member is positioned on the dielectric so as to extend generally parallel to the periphery of the dielectric.

Preferably, the ground coupling member and the grounded frame extend on opposite sides of the dielectric when the dielectric has been fitted into the grounded frame.

Preferably, when the dielectric has been fitted into the grounded frame, all or some of the ground coupling member faces the grounded frame extending on the opposite side of the dielectric.

Preferably, when the dielectric has been fitted into the grounded frame and the electrical coupling exists between the ground coupling member and the frame, a gap existing between the coupling member and frame is equal to or less than one-tenth of the wavelength of signals associated with the first antenna element.

Preferably, the ground coupling member has first and second linear arms extending at an angle to each other, and wherein the signal-ground connection point is at a meeting of the arms. More preferably, the first and second arms are approximately the same length.

Preferably, each signal-feed connection point and associated signal-ground connection point are a pair of inputs to a respective amplifier situated proximate the respective signal-feed connection point. More preferably, each amplifier has a pair of outputs and, with the dielectric fitted in the grounded frame, each pair of outputs are connected to a respective coaxial cable that extends away from the antenna assembly.

Preferably, the dielectric is a window for a vehicle, and each antenna element is formed by conductive ink printed on the dielectric. More preferably, the ground coupling member is also formed by conductive ink printed on the dielectric. Etched patterns on films may also be used.

Preferred features of the present invention will now be described, by way of example only, with reference to the accompanying drawings, in which:

FIG. 1 is a plan view of a conventional arrangement of an antenna element extending on a dielectric that is mounted in an aperture of a grounded body;

FIG. 2A illustrates an electrically-long connection between the antenna element of FIG. 1 and a signal feedline providing a signal to the antenna element;

FIG. 2B is a schematic circuit of the arrangement of FIG. 2A, illustrating an inductance which results from the connection shown in FIG. 2A with the antenna element;

FIG. 3A illustrates a connection between an antenna element on a dielectric and a coaxial cable having its ground extended past the periphery of the dielectric;

FIG. 3B is a schematic circuit of the arrangement of FIG. 3A, illustrating an inductance which results from the connection of the coaxial cable shown in FIG. 3A;

FIG. 4 is a plan view of a first embodiment of the integrated antenna of the subject invention, a coaxial cable having its ground connected to a ground coupling member which extends on the dielectric and is electrically-coupled to the grounded body;

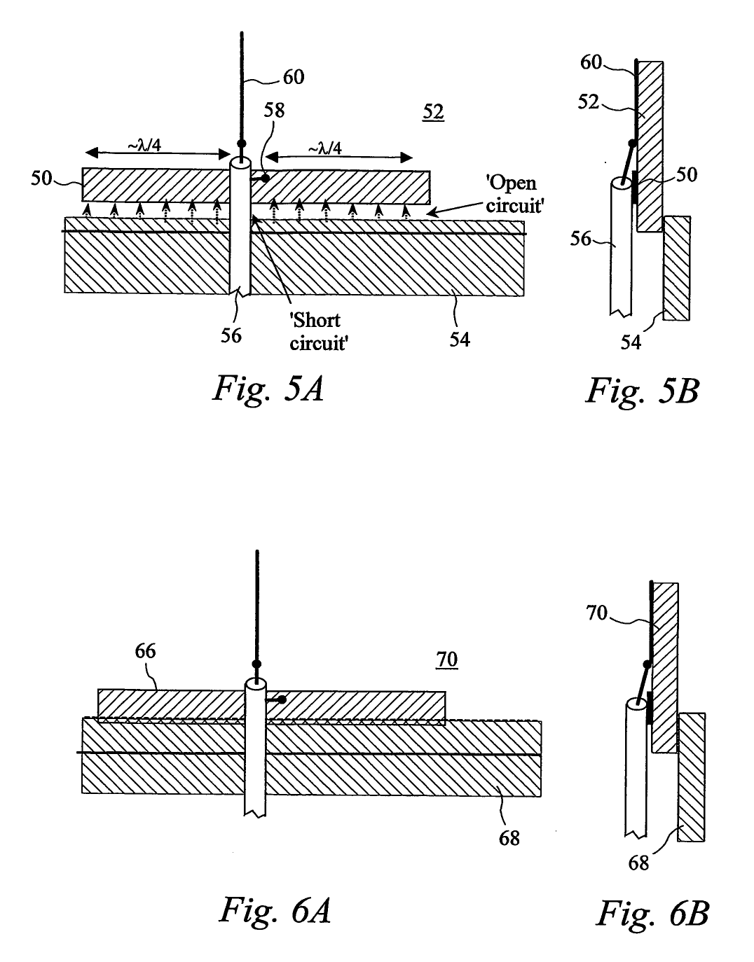

FIG. 5A is a plan view of a second embodiment of the integrated antenna of the subject invention, a ground coupling member forming a slot line with the grounded body and having the ground of a coaxial cable connected thereto, the view illustrating the electrical field between the ground coupling member and the grounded body;

FIG. 5B is a side view of the second embodiment of FIG. 5A;

FIG. 6A is a plan view of a third embodiment of the integrated antenna of the subject invention, the third embodiment differing from the second embodiment in that portions of the ground coupling member and grounded body face each other on opposite sides of the dielectric;

FIG. 6B is a side view of the third embodiment of FIG. 6A;

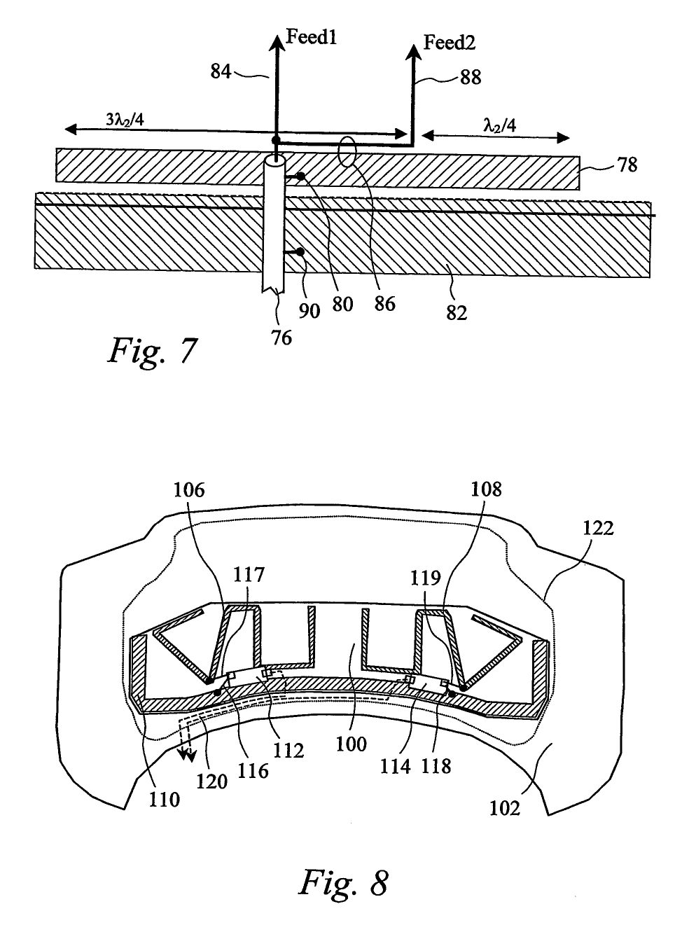

FIG. 7 is a plan view of a fourth embodiment of the integrated antenna of the subject invention, the view being similar to the second embodiment but having a second signal feedline for connecting to a second antenna element;

FIG. 8 is a perspective view of a fifth embodiment of the integrated antenna of the subject invention, the view illustrating the positioning of a dielectric panel of the antenna in a vehicle boot (shown open);

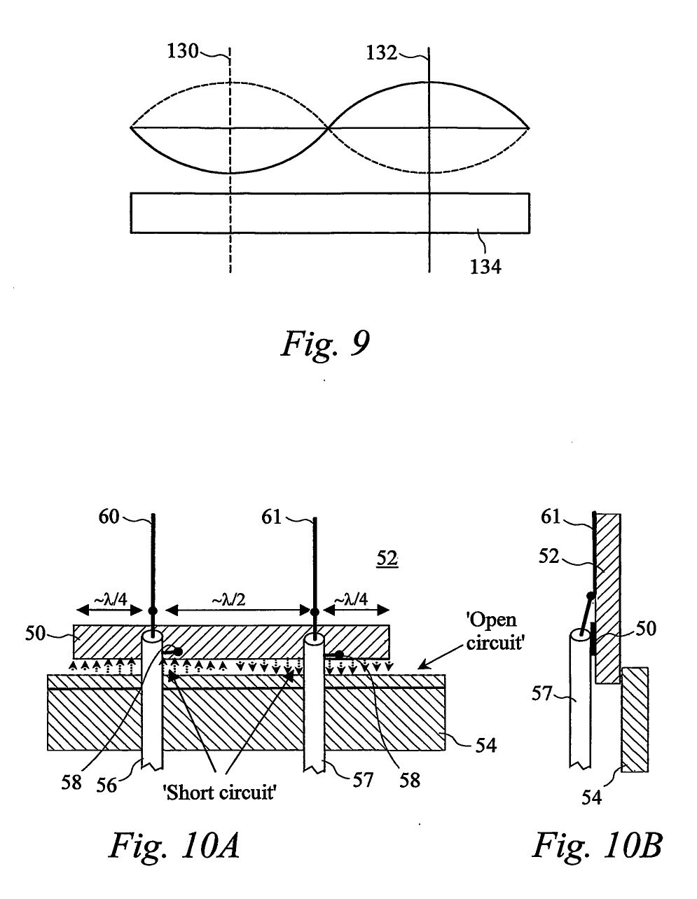

FIG. 9 illustrates the position of the pair of feed wires relative to the position of the ground coupling member for the integrated antenna of FIG. 8;

FIG. 10A is a plan view of an integrated antenna having the spacing of the feed wires that is illustrated in FIG. 9; and,

FIG. 10B is a side view of the integrated antenna of FIG. 10A.

The first embodiment of the antenna of the invention is illustrated in FIG. 4. A grounded vehicle body 30 has an aperture 32 into which is fitted a glass panel 34. The outer edges of glass panel 34 are shown as extending slightly outside of the edges of aperture 32 to depict the fitting of the one in the other. An antenna element 36 is formed by a conductive ink pattern on the surface of the glass panel 34. A ground coupling member 38, also formed by a conductive ink pattern, has first and second arms that extend normal to each other and meet at one end. When viewed normal to the glass panel 34, the two arms of the ground coupling member 38 form a respective gap 40, 42 with respective edges of the vehicle body 30. A coaxial cable 44 extends over the vehicle body 30, and has its ground connected to ground coupling member 38 at the meeting point 46 of the two arms. The live of coaxial cable 44 extends to connect with the effective end of antenna element 36.

The lengths of the two arms of ground coupling member 38 are each ideally λ/4 (one-quarter wavelength) at the operating frequency of the antenna element 36. Each of the two arm of the ground coupling member 38 forms, with the respective edge of the vehicle body 30, what is termed a “slot line”. The outer end of each arm of the ground coupling member 38 is “open-circuit”, and the slot line transforms this to a low impedance at the central point between the outer ends of the arms; a “virtual-earth” is thereby generated at the central point. Thus, the ground of the coaxial cable 44 (earth of an unbalanced transmission line) is coupled directly to the vehicle body 30 (main chassis earth) in the vicinity of the feed point to the antenna element.

For optimum performance, the feeding coaxial cable 44 needs to cross the slot gaps 40 and 42 near the virtual earth to minimize any loading effect on the slot line; in FIG. 4, the virtual earth is the point at which the slot gaps 40 and 42 meet. The coaxial cable 44 may also have its ground connected directly to the vehicle body 30. The position of such second ground connection, which would be used mainly for EMC purposes or to provide a local DC ground for an amplifier, now has little effect on the performance of the antenna element 36.

In practice, the geometry of the slot lines will be dictated by the structure of the particular vehicle. It may be difficult to determine the exact electrical impedance or wave velocity of the slot lines, and their position will need to be optimised empirically. Hence, in FIG. 4, the arms of the ground coupling member 38 may in fact have unequal lengths (L1 not equal to L2) when the virtual earth is found empirically to be at the meeting point 46 of the arms.

FIGS. 5A and 5B illustrate a second embodiment of the invention. This differs from the foregoing first embodiment only in that the ground coupling member 50 has a straight rather than bent configuration. The ground coupling member 50 is formed on a glass sheet 52 in an aperture of a vehicle body 54. The ground coupling member 50 is approximately λ/2 in length, and a ground of the coaxial cable 56 is connected to the ground coupling member 50 at a central location 58. FIG. 5A illustrates the electrical field in the slot gap between the ground coupling member 50 and the vehicle body 54, with the ends of the slot gap being effectively open-circuited and the central location 58 being effectively short-circuited. The antenna element is designated as 60.

To improve the bandwidth over which the slot lines operate, the capacitance between each arm of the ground coupling member and the respective edge of the vehicle body should be made as large as possible. The most preferred embodiment would be the third embodiment that is shown in FIGS. 6A and 6B, in which the ground coupling member 66 partially overlies the edge of the vehicle body 68. Here the glass (about 5 mm-thickness) on which the ground coupling member 66 is formed is designated as 70. The arrangement shown in FIGS. 6A and 6B does, however, have practical restraints and is not normally achievable. Also, this embodiment is obviously only applicable in situations where the ground coupling member and the grounded frame are extending on opposite sides of the dielectric; the other embodiments do not have such limitation.

Preferably, the ground coupling member is formed together with the antenna element. This can be achieved by printing on glass with a screen element, or onto the same thin dielectric substrate with a film antenna element. The surface area of the ground coupling member is ideally made as large as possible, since it forms part of the earth. However, increasing the width of the ground coupling member will reduce the aperture size available for the antenna element itself, which is detrimental and undesirable. Also, the main capacitive effect in determining the slot line (location of the ground coupling member) will be edge-coupling between the ground coupling member and the vehicle body. Invariably, the optimum shape for the ground coupling member will be as a strip, with width much less than length.

In most vehicle antenna applications, operation at more than one frequency is often necessary. For instance, modern radio reception requires reception in the LW (Longwave), MW (Mediumwave), FM (Frequency-Modulated Broadcast) and DAB (Digital Audio Broadcast) bands. For reception at FM frequency, a typical coupled-line structure as shown in FIG. 7 can be developed. In this fourth embodiment, the coaxial cable 76 has its ground connected to the ground coupling member 78 at position 80, which is located approximately midway between the two ends of the ground coupling member 78. The vehicle body is here designated as 82. Position 80 is the virtual-earth for Feed1, and allows for optimized reception from the antenna element 84 at 100 MHz. However, antenna element 84 (Feed1) is not very effective at 200 MHz, where Band III (DAB) reception operates. In this instance, it may be possible to provide a second feed (Feed2) for Band III, offset from the main feed and using a co-planar feedline 86 and a second antenna element 88. This is possible because the length of the ground coupling member 78 is not only equal to λ₁/2 at 100 MHz but is also equal to λ₂ with respect to DAB reception at 200 MHz on Feed2. The feedline 86 remains electrically-coupled to the ground coupling member 78 until it reaches a position that is λ₂/4 distant from the one end of the ground coupling member 78 (and 3λ₂/4 distant from the other end). At the higher DAB Band (1.5 GHz), the ground coupling member 78 can be made electrically-large, and this will provide a local earth by itself.

For LW and MW reception, however, the ground coupling member 78 is now electrically-small so the ground of the coaxial cable 76 can therefore be connected directly to the vehicle body 82 at position 90. Although the electrical-coupling provided by the ground connection 80 on ground coupling member 78 operates at the FM/DAB frequencies, it has little effect at the lower LW and MW frequencies.

A fifth embodiment of the invention is next described with reference to the car boot shown in FIG. 8. The fifth embodiment is an AM/FM diversity film antenna developed for use on a vehicle having a metallic chassis and a plastic boot lid. A film antenna having a dielectric panel 100 that is pre-shaped to fit the boot cavity is clipped onto the inside surface of the boot. Two FM antenna elements 106 and 108 and a ground coupling member 110 are printed, using conductive ink, onto the panel 100 before installation of the panel in the boot. The ground coupling member 110 is connected to amplifier modules 112 and 114 using respective short ground wires 116 and 118 that are crimped onto the panel 100; as also shown in FIG. 8, the amplifier modules 112 and 114 are also connected by short feed wires 117 and 119 to the two antenna elements 106 and 108. The amplifier modules 112 and 114 are bolted onto the inside surface of the boot, which surface also serves to hold the panel 100 in place. The outputs of the amplifier modules 112 and 114 are connected to a tuner (not shown) via coaxial cables. Those coaxial cables are not shown in FIG. 8, but their routing is shown in outline designated as 120. It can be seen that the coaxial cable routing from the amplifier module 114 runs generally in parallel with the ground coupling member 110 between the pair of modules 112 and 114, and then passes off the boot in parallel with the coaxial cable from the amplifier module 112. The cables extend over one of the hinges holding the car boot to the car chassis, and exit the boot in a region where the ‘coupled ground’ is creating a low impedance (virtual earth); the pair of cables thereby do not load the coupled-earth slot lines unnecessarily.

The ground coupling member 110 is contoured to extend along a longer edge of the dielectric panel 100 such that it remains within the boot trim, as shown in FIG. 8. The path of ground coupling member 110 follows the aperture (dotted line 122) of the boot cavity in the car chassis, creating the required slot transmission line. The distance between open ends of the ground coupling member 110 and the signal feed points are tuned in the same way as described above for the first embodiment, with the separation between feed points being one-half of the wavelength. In this embodiment the ground coupling member 110 provides a coupled ground for both antenna elements 106 and 108 separately (there are two “virtual earths”—one near each feed).

FIG. 8 therefore depicts an arrangement of two efficient antenna structures that together provide FM antenna diversity.

For the FIG. 8 embodiment, FIG. 9 illustrates the position of the pair of feed wires to the first and second antenna elements, relative to the position of a ground coupling member; the feed-wire positions are designated 130 and 132, with 134 designating the proximate ground coupling member. In FIG. 9, the wavelength λ of signals associated with the first antenna element is the same as that of signals associated with the second antenna element but 180° out-of-phase, the wavelength being equal to the length of the ground coupling member 134.

FIGS. 10A and 10B are respectively a plan view and side view of the integrated antenna of the version of the fifth embodiment having the feed wires positioned as shown in FIG. 9, with the signal-feed connection points being separated by λ/2 and with each signal-feed connection point being λ/4 from a respective end of the ground coupling member. The parts numbering in FIGS. 10A and 10B is similar to that in FIGS. 5A and 5B, but additionally shown are a second coaxial cable 57 and a second antenna element 61.

In the foregoing description, the term “wavelengths of signals associated with an antenna element” is intended to mean the wavelengths of all signals in the frequency band associated with the antenna element. Where the symbol λ is used, it should be understood to represent a typical mid-frequency wavelength or centre-frequency wavelength of the particular frequency band to be transmitted and/or received on a particular antenna element.

While the present invention has been described in preferred embodiments, it is to be understood that the words which have been used are words of description rather than limitation, and that changes may be made to the invention without departing from its scope as defined by the appended claims.

Each feature disclosed in this specification (which term includes the claims) and/or shown in the drawings may be incorporated in the invention independently of other disclosed and/or illustrated features.

The text of the abstract filed herewith is repeated here as part of the specification.

An integrated antenna includes a dielectric on which is patterned an antenna element and on which, close to an edge of the dielectric, is also patterned a conductive ground coupling member. The ground coupling member in capable of electrical-coupling with a grounded body surrounding the dielectric to provide a ground for an unbalanced transmission line whose live is connected to the antenna element. The length of the ground coupling member is made such that an integral odd number of quarter-wavelengths of signals at each operating frequency are adapted to extend either side of a signal-ground connection point; the length approximates one-half wavelength at the primary operating frequency. By including a second signal feedline to extend in parallel with the ground coupling member and connect with another antenna element, it is possible for the integrated antenna to receive/transmit on at least two frequencies. The invention finds application in integrated antenna structures in which a local ground connection is not readily possible. For instance, the dielectric and grounded body may be a respective window and chassis of a car. Another automotive application involves forming the integrated antenna on a plastic boot lid.

1. An antenna assembly comprising:
a dielectric adapted to be fitted into a grounded frame;
a ground coupling member, extending on the dielectric and having first and second signal-ground connection points, the position of the ground coupling member on the dielectric being such that when the dielectric is fitted into the grounded frame the ground coupling member and the frame are spaced from each other but have an electrical coupling;
a first antenna element patterned on the dielectric to extend to a first signal-feed connection point on the dielectric, the first signal-feed connection point being located proximate the first signal-ground connection point; and,
a second antenna element patterned on the dielectric to extend to a second signal-feed connection point on the dielectric, the second signal-feed connection point being located proximate the second signal-ground connection point;
wherein, if λ₁ and λ₂ designate the wavelengths of signals respectively associated with the first and second antenna elements:
the total length of the ground coupling member is equal to mλ₁/2 and nλ₂/2, where m and n are integers and not simultaneously equal to 1;
the distance separating the first signal-feed connection point from the second signal-feed connection point is greater than λ₂/4, where λ₂≦λ₁;
the first signal-feed connection point is located proximate the first ground coupling member at a distance λ₁/4, or an odd-integer multiple of that distance, from one end of the ground coupling member; and,
the second signal-feed connection point is located proximate the second ground coupling member at a distance λ₂/4, or an odd-integer multiple of that distance, from the one end of the ground coupling member.

2. The antenna assembly of claim 1, wherein λ₁ is equal to λ₂, and signals associated with the first antenna element are 180° out-of-phase with signals associated with the second antenna element.

3. The antenna assembly of claim 2, wherein m and n are both 2, and the first and second signal-feed connection points are separated by λ₂/2.

4. The antenna assembly of claim 2, wherein m and n are both 3, and the first and second signal-feed connection points are separated by λ₂/2 or λ₂.

5. The antenna assembly of claim 2, wherein m and n are both 4, and the first and second signal-feed connection points are separated by λ₂/2, λ₂ or 3λ₂/2.

6. An antenna assembly comprising:
a dielectric adapted to be fitted into a grounded frame;
a ground coupling member, extending on the dielectric and having a signal-ground connection point, the position of the ground coupling member on the dielectric being such that when the dielectric is fitted into the grounded frame the ground coupling member and the frame are spaced from each other but have an electrical coupling;
a first antenna element patterned on the dielectric to extend to a signal-feed connection point on the dielectric; and,
a second antenna element patterned on the dielectric to extend to the signal-feed connection point, a feed portion of the second antenna element extending generally parallel to the ground coupling member from the signal-feed connection point to a feed-portion termination point; wherein:
the wavelengths of signals associated with the first antenna element are twice, or a multiple of twice, the wavelengths of signals associated with the second antenna element; and,
the distance between the signal-feed connection point and the feed-portion termination point is approximately one-quarter wavelength, or an odd-integer multiple of that one-quarter wavelength, of signals associated with the second antenna element.

7. The antenna assembly of claim 6, wherein the feed-portion termination point is separated from a closer first end of the ground coupling member by a distance equal to one-quarter wavelength, or an odd-integer multiple of that one-quarter wavelength, of signals associated with the second antenna element.

8. The antenna assembly of claim 6 or 7, wherein the signal-feed connection point is separated from the second end of the ground coupling member by a distance equal to one-quarter wavelength, or an odd-integer multiple of that one-quarter wavelength, of signals associated with the first antenna element.

9. The antenna assembly of any of claims 6 to 8, wherein the length of the ground coupling member approximates one-half wavelength of signals associated with the first antenna element.

10. The antenna assembly of any of claims 6 to 9, wherein the length of the ground coupling member approximates the wavelength of signals associated with the second antenna element.

11. The antenna assembly of any preceding claim, wherein the electrical coupling is adapted to be between the ground coupling member and a co-planar portion of the frame.

12. The antenna assembly of any preceding claim, wherein the electrical coupling is capacitive coupling.

13. The antenna assembly of any preceding claim, wherein the ground coupling member is positioned on the dielectric so as to extend generally parallel to the periphery of the dielectric.

14. The antenna assembly of any preceding claim, wherein the ground coupling member and the grounded frame extend on opposite sides of the dielectric when the dielectric has been fitted into the grounded frame.

15. The antenna assembly of claim 14, wherein, when the dielectric has been fitted into the grounded frame, all or some of the ground coupling member faces the grounded frame extending on the opposite side of the dielectric.

16. The antenna assembly of any preceding claim, wherein, when the dielectric has been fitted into the grounded frame and the electrical coupling exists between the ground coupling member and the frame, a gap existing between the coupling member and frame is equal to or less than one-tenth of the wavelength of signals associated with the first antenna element.

17. The antenna assembly of any preceding claim, wherein the ground coupling member has first and second linear arms extending at an angle to each other, and wherein the signal-ground connection point is at a meeting of the arms.

18. The antenna assembly of claim 17, wherein the first and second arms are approximately the same length.

19. The antenna assembly of any preceding claim,. wherein each signal-feed connection point and associated signal-ground connection point are a pair of inputs to a respective amplifier situated proximate the respective signal-feed connection point.

20. The antenna assembly of claim 19, wherein, each amplifier has a pair of outputs and, with the dielectric fitted in the grounded frame, each pair of outputs are connected to a respective coaxial cable that extends away from the antenna assembly.

21. The antenna assembly of any preceding claim, wherein the dielectric is a window for a vehicle, and each antenna element is formed by conductive ink printed on the dielectric.

22. The antenna assembly of claim 21, wherein the ground coupling member is also formed by conductive ink printed on the dielectric.
